(19) United States
(12) Patent Application Publication
(10) Pub. No.: US 2020/0251012 A1
(43) Pub. Date: Aug. 6, 2020

(54) EDUCATIONAL MONITORING AND NOTIFICATION SYSTEM

(71) Applicant: Strongmind, Inc., Chandler, AZ (US)

(72) Inventors: Damian Creamer, Chandler, AZ (US); Michael Bovich, Chandler, AZ (US); Skyler Todd, Chandler, AZ (US); Michael Graf, Chandler, AZ (US)

(73) Assignee: Strongmind, Inc., Chandler, AZ (US)

(21) Appl. No.: 16/781,488

(22) Filed: Feb. 4, 2020

Related U.S. Application Data
(60) Provisional application No. 62/800,690, filed on Feb. 4, 2019.

(51) Int. Cl. G09B 19/00

(52) U.S. Cl. CPC G09B 19/00

(57) ABSTRACT

A system may perform operations including receiving a filter parameter associated with a desired information attribute, wherein the filter parameter indicates that academic information having the desired information attribute is relevant to a user profile; accessing new academic information associated with an academic event; analyzing the new academic information for the desired information attribute associated with the filter parameter; identifying the desired information attribute in the new academic information; generating, by the processor, a notification in response to the identifying the desired information attribute in the new academic information; and/or presenting the notification on a user device associated with the user profile.

### CROSS REFERENCE TO RELATED APPLICATIONS

This application is a nonprovisional of, and claims priority to and the benefit of, U.S. Provisional Patent Application Ser. No. 62/800,690, filed Feb. 4, 2019 and entitled “EDUCATIONAL MONITORING AND NOTIFICATION SYSTEM,” which is hereby incorporated by reference.

### FIELD

The present disclosure generally relates to a system for providing notifications to users of the system regarding the actions taken and task progress of other users within the system.

### BACKGROUND

Keeping informed on a student's academic behavior and progress can be a daunting task for both teachers and parents alike. This becomes especially difficult in the realm of virtual schools, in which students attend class from remote locations by logging on via the Internet to a prescribed session hosted by a teacher in a different location. Additionally, accessing updates to a student's actions and progress may be burdensome, requiring logging into a secure portal or system from a computer scanning through large volumes of information, most of which may be irrelevant to the viewer, just to check if there are any relevant updates about the student. Finally, a student's actions and progress in an educational program may take time to update, and therefore, the information available for a given student may be dated by the time a viewer sees the update.

### SUMMARY

Systems and methods are disclosed relating to an information distribution system. In various embodiments, the system may be configured to notify a user (e.g., a parent) of an observed person's (e.g., a student's) actions or progress on a task or program. The user may set a filter parameter(s) which dictate when a notification will be sent to the user. That is, the user may select filter parameters which indicate the academic information, having desired information attributes associated with the selected filter parameters, about which the user would like to be notified via a notification. The notification system may send a notification, such as a push notification or pop-up notification, to a desired location (e.g., a certain communication channel, such as email, social media profile, text message, or the like). The user may access the notifications received at the user's convenience and navigate to more detailed descriptions of the events associated with the notifications.

A system, method, and article of manufacture (collectively, “the system”) are disclosed relating to an information distribution system. In various embodiments, the system may be configured to perform operations including, receiving, by a processor, a filter parameter associated with a desired information attribute, wherein the filter parameter indicates that academic information having the desired information attribute is relevant to a monitoring user profile; accessing, by the processor, new academic information associated with an academic event; analyzing, by the processor, the new academic information for the desired information attribute associated with the filter parameter; identifying, by the processor, the desired information attribute in the new academic information; transmitting, by the processor, the new academic information to the monitoring user profile in response to the identifying the desired information attribute; generating, by the processor, a notification in response to identifying the desired information attribute in the new academic information, the notification comprising at least one of the filter parameter, the desired information attribute, the new academic information, or a symbol or text representing at least one of the filter parameter, the desired information attribute, or the new academic information associated with the academic event; and/or presenting, by the processor, the notification on a user device associated with the user profile.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the drawing figures.

FIG. 1 illustrates an exemplary information distribution system, in accordance with various embodiments; and

FIG. 2 illustrates a flowchart depicting an exemplary method for generating and presenting information notifications by utilizing an information distribution system, in accordance with various embodiments.

### DETAILED DESCRIPTION

The detailed description of various embodiments herein makes reference to the accompanying drawings, which show the exemplary embodiments by way of illustration. While these exemplary embodiments are described in sufficient detail to enable those skilled in the art to practice the disclosure, it should be understood that other embodiments may be realized, and that logical and mechanical changes may be made without departing from the spirit and scope of the disclosure. Thus, the detailed description herein is presented for purposes of illustration only and not of limitation. For example, the steps recited in any of the method or process descriptions may be executed in any order and are not limited to the order presented. Moreover, any of the functions or steps may be outsourced to or performed by one or more third parties. Furthermore, any reference to singular includes plural embodiments, and any reference to more than one component may include a singular embodiment.

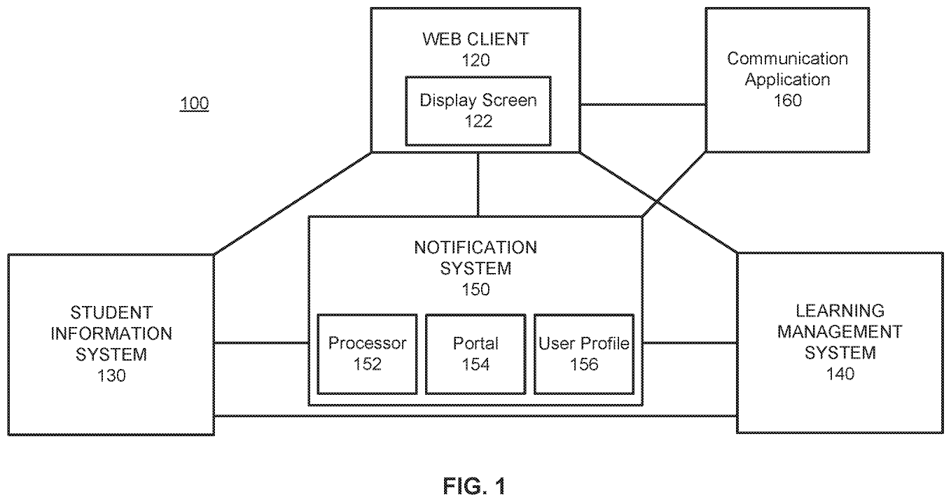

With reference to FIG. 1, an exemplary information distribution system 100 is illustrated, in accordance with various embodiments. System 100 may allow a monitoring user (a person monitoring another person's behavior and/or progress) to receive notifications reflecting academic information (e.g., relating to an academic event) having desired information attributes associated with the actions or progress of an observed person (e.g., a student, or another person being observed by the monitoring user). For example, a monitoring user may be a teacher or a parent, and the observed person may be a student. The monitoring user may wish to receive notifications of academic events (e.g., updates, statuses, etc. relating to the student's academic actions or performance, such as a truancy, tardiness, an evaluation score (e.g., grade) of a certain level (high or low), or any other academic event of interest). Utilizing system 100, academic information associated with an academic event received by system 100 may be analyzed for a desired information attribute. Academic information comprising the desired information attribute may be the academic information about which the user has indicated to system 100 that the user would like to remain informed (i.e., receive notifications relating to academic information comprising the desired information attribute).

In various embodiments, system 100 may comprise a web client 120, a student information system (SIS) 130, a learning management system (LMS) 140, a notification system 150, and/or a communication application 160. In various embodiments, any or all of the components of system 100 may be integrated, and/or in electronic communication, with one another via one or more application programming interfaces (APIs). System 100 and/or any of the components comprised therein may be computer-based, and may comprise a processor (e.g., processor 152), a tangible non-transitory computer-readable memory, and/or a network interface. Instructions stored on the tangible non-transitory memory may allow system 100, or any one or more of the components therein, to perform various functions, as described herein. In various embodiments, one or more processors (e.g., processor 152) may control, preform, and/or facilitate the functions of all components of system 100.

In various embodiments, web client 120 may incorporate hardware and/or software components. For example, web client 120 may comprise a server appliance running a suitable server operating system (e.g., MICROSOFT INTERNET INFORMATION SERVICES or, “IIS”). Web client 120 may be any device that allows a user to communicate with a network (e.g., a personal computer, personal digital assistant (e.g., IPHONE®, BLACKBERRY®), tablet, cellular phone, kiosk, and/or the like). Web client 120 may be in electronic communication with SIS 130, LMS 140, notification system 150, and/or communication application 160. Web client 120 may allow the user of system 100 to interact with the other components of system 100. In various embodiments, web client 120 may comprise an input device (i.e., a physical or digital button), by which the user may select actions for web client 120 or system 100 (and the components therein) to take. For example, web client 120 may comprise display screen 122, which may display a graphical user interface (GUI) and/or portal 154 provided by notification system 150. Display screen 122 displaying portal 154 may allow the user to select an input device(s), which may be provided by the GUI or portal 154, to communicate to system 100 a desired action by system 100.

Web client 120 includes any device (e.g., personal computer, mobile device, etc.) which communicates via any network, for example such as those discussed herein. In various embodiments, web client 120 may comprise and/or run a browser, such as MICROSOFT® INTERNET EXPLORER®, MOZILLA® FIREFOX®, GOOGLE® CHROME®, APPLE® Safari, or any other of the myriad software packages available for browsing the internet. For example, the browser may communicate with a server via network by using Internet browsing software installed in the browser. The browser may comprise Internet browsing software installed within a computing unit or a system to conduct online transactions and/or communications. These computing units or systems may take the form of a computer or set of computers, although other types of computing units or systems may be used, including laptops, notebooks, tablets, handheld computers, personal digital assistants, set-top boxes, workstations, computer-servers, mainframe computers, mini-computers, PC servers, pervasive computers, network sets of computers, personal computers, such as IPADS®, IMACS®, and MACBOOKS®, kiosks, terminals, point of sale (POS) devices and/or terminals, televisions, or any other device capable of receiving data over a network. In various embodiments, browser may be configured to display an electronic channel.

In various embodiments, SIS 130 may incorporate hardware and/or software components. For example, SIS 130 may comprise a server appliance running a suitable server operating system (e.g., MICROSOFT INTERNET INFORMATION SERVICES or, “IIS”) and having database software (e.g., ORACLE) installed thereon. SIS 130 may integrate and electronically communicate with web client 120, LMS 140, and/or notification system 150. In various embodiments, SIS 130 may be configured to perform functions relating to the facilitation of student services (e.g., enrollment, scheduling, etc.) and storage and retention of student information (e.g., personal information, grade, examination and assignment scores, attendance record, etc.). For example, SIS 130 may provide instructors with user profiles (i.e., teacher profiles), which may comprise student information for the various students enrolled in the class(es) the instructor is teaching. An instructor or teacher may be a representative of the school and/or a facilitator of a student's education. The instructors, through SIS 130 and the teacher profile, may enter student information, such as assignment or examination scores (e.g., grades), behavioral events (e.g., detentions, referrals, awards, etc.), attendance, feedback, or the like. SIS 130 may also store and make available student information such as class schedule, workload, educational history, achievements, incidents, or other academic information pertinent to a student's continuing education. Relatedly, SIS may also comprise profiles for students (i.e., student user profiles), into which a student may log in and access their own information, and input information. SIS 130 may appropriately limit the information available to each user. For example, a student may only have access to the student's own information, and a teacher may only have access to the teacher's own information, as well as student information for the students whose education the teacher is currently involved.

In various embodiments, LMS 140 may incorporate hardware and/or software components. For example, LMS 140 may comprise a server appliance running a suitable server operating system (e.g., MICROSOFT INTERNET INFORMATION SERVICES or, “IIS”) and having database software (e.g., ORACLE) installed thereon. LMS 140 may integrate and electronically communicate with web client 120, SIS 130, and/or notification system 150. In various embodiments, LMS 140 may be configured to perform functions relating to the facilitation of educational courses or programs (e.g., classes). For example, LMS 140 may provide instructors with teacher profiles and students with student user profiles to access the information available in LMS 140. LMS 140 may also provide webpages for specific classes, which the instructor(s) teaching the class may access and monitor, and may control the content of the class webpage through the instructor's teacher profile. Instructors may post and distribute reading materials, presentations, assignments, projects, syllabi, videos (e.g., for class instruction, explanation, etc.), and any other materials associated with the class or curriculum. The students enrolled in the class may access the respective class website(s) through their student user profiles and download the materials posted by the instructor, upload completed assignments or projects, complete online assignment or exams, or take other actions as required and/or allowed by the instructor. Students may also upload information through their student user profiles. A student's class information and materials/resources may be comprised in the student user profile for the respective student. LMS 140 may allow the creation and administration of online examinations, assignments, or other evaluative materials by an instructor, and the students may complete such evaluative materials online. LMS 140 may grade the evaluative materials completed by the students, or the instructor may manually grade. LMS 140 may also provide the ability to host discussion boards between instructors and students, in which the participants may post communications (e.g., questions, comments, images, videos), and other participants may post communications in response or addition to the previous communications.

Similar to SIS 130, in various embodiments, the instructors, through LMS 140, may enter student information through the teacher profile, such as assignment or examination scores (e.g., grades), behavioral events (e.g., detentions, referrals, awards, etc.), attendance, feedback, or the like. LMS 140 may also store and make available student information such as class schedule, workload, or other academic information. The students may only access information related to themselves through their respective student user profiles, but shared materials and discussion boards may be accessed by multiple students (access may be determined by the instructor, and inputted into LMS 140).

In various embodiments, parents of students, or other authorized persons (e.g., administrators, legal guardians, private tutors) may have an authorized person profile (i.e., a parent profile). A parent profile may belong to a user who has a guardian-type role over a student, such that the parent user is not affiliated with the school, but has a recognized interest in the associated student's well-being and education (e.g., a biological, adoptive, step, or foster parent, and/or someone with like legal guardian status). Through the parent profile, the parent may access the student user profile of the student with which the parent is associated (e.g., a parent's child), receive notifications or information regarding the student, post communications to the student user profile or a teacher profile for a class in which the student is enrolled, download materials for the student's class(es), or receive or obtain other information relevant to the students education or curriculum. The parent profile may be on SIS 130 and/or LMS 140, and in various embodiments, may be a separate profile for the parents with access to the associated student user profile, such that the parent may store or access information in the parent profile as well as view the information comprised within the student user profile (e.g., by receiving updates in the parent profile and/or by accessing the student user profile). In various embodiments, parents may be given access directly to the student user profile of the associated student, and the parent profile may be a modified version of the student user profile with functionality for the parent as described above.

Despite having access to the academic and education information comprised in or related to a student user profile (e.g., available in SIS 130 and/or LMS 140), accessing the student user profile and/or other relevant information may be a burdensome task for a parent. Additionally, sifting through all of the information from a student user profile may be inefficient because much of the information may be irrelevant or inconsequential from a parent's perspective. Therefore, these tasks a parent must perform to access and/or view relevant information about their respective student's education (e.g., log in, search, etc.) may be too high a barrier to justify continually monitoring the student's academic information.

In various embodiments, notification system 150 may comprise hardware and/or software capable of storing data and/or analyzing information. Notification system 150 may comprise a server appliance running a suitable server operating system (e.g., MICROSOFT INTERNET INFORMATION SERVICES or, “IIS”) and having database software (e.g., ORACLE) installed thereon. Notification system 150 may be in electronic communication with web client 120, SIS 130, LMS 140, and/or communication application 160 via respective APIs and/or a network. In various embodiments, notification system 150 may comprise a user profile(s) 156 (e.g., student user profiles, parent profiles, teacher profiles, and/or administrator profiles, depending on the user) similar to SIS 130 and/or LMS 140, having similar functions, uses, and/or capabilities. Notification system 150 may be configured to send notifications to a monitoring user profile 156 associated with a user (e.g., a parent) to notify the user of events, trends, or other information occurring in an observed user profile (e.g., associated with a student, teacher, or any other person being observed by the monitoring user profile 156). As used herein, “monitoring user profile” may be a user profile 156 in notification system 150 which receives notifications from notification system 150 regarding academic information associated with a user profile in SIS 130, LMS 140, and/or notification system 150, which the monitoring profile is monitoring. An “observed user profile” may be the user profile in SIS 130, LMS 140, or notification system 150 monitored by the monitoring user profile 156. A monitoring profile may be utilized by a parent, a teacher/instructor, an administrator, or the like, which may monitor a student user profile. An observed user profile may belong to a student. In a further example, the monitoring user profile may be associated with a student, and the observed user profile may be utilized by a teacher, such that the student may monitor the teacher's activities to stay apprised of current assignments and educational materials.

In various embodiments, user profile 156 may belong and/or be associated with a user of system 100 and/or notification system 150, and may comprise any information or data about the user (e.g., a preference, an association, an interest, demographic information, personally identifying information, and/or the like). User profile 156 may comprise a server appliance running a suitable server operating system (e.g., MICROSOFT INTERNET INFORMATION SERVICES or, “IIS”) and having database software (e.g., ORACLE) installed thereon. In various embodiments, user profile 156 may be comprised in a separate system from notification system 150, but may be accessible by notification system 150. In various embodiments, notification system 150 may comprise multiple user profiles 156, each being associated with a user.

In various embodiments, one user profile 156 (e.g., a parent profile) may be associated and/or linked with another user profile 156 (e.g., a student user profile for a student to which the user has an association, or a teacher profile for an instructor teaching the associated student). Further, user profile 156 in notification system 150 may be associated and/or linked to a user profile in SIS 130 and/or LMS 140 for the same user or another associated user (e.g., a student user profile 156 may be associated with the student's profiles in SIS 130 and/or LMS 140, or a parent's user profile 156 may be associated with the parent's child's user profile in SIS 130 and/or LMS 140).

A user profile 156 may be created by a user registering with notification system 150, which may include creating a username and password, providing user information, etc. User profile 156 may be based upon and/or comprise data contributed by the associated user, or other users of system 100 and/or notification system 150. For example, a consumer may contribute data towards a consumer profile by way of a form and/or questionnaire, such as, for example, a web-based form or questionnaire. A user profile 156 for a student (a student user profile) may comprise academic information associated with the student's education, class schedule, workload, educational history, achievements, incidents, or other academic information pertinent to a student's continuing education. A user profile 156 for an instructor (a teacher profile) may comprise information about the teacher, class curriculum, syllabi, materials, assignments, exams, and/or other resources for students and their relatives (e.g., parents). A user profile 156 for a parent may comprise similar information as the student user profile 156, but may also comprise information about the associated student and the observed user profile associated with the student. The parent user profile 156 may additionally comprise preferences regarding the types of academic information about which the parent would like to remain informed and receive notifications, as discussed herein.

In various embodiments, each user profile (e.g., user profiles in SIS 130 and/or LMS 140, and/or user profiles 156 in notification system 150) may comprise a user identifier associated with the user and the user profile. For example, if the user is a student, the user identifier may be a student ID. The user identifier may comprise a series of numbers, letters, and/or other symbols that uniquely identifies the user and/or associated user profile. Different aspects of a user profile may comprise identifiers as well, such as the school in which a student is enrolled (e.g., a school ID), the student section that the student is in (e.g., a section ID), the associated class (e.g., a course ID), an associated instructor and teacher profile (e.g., a teacher ID), a specific assignment (e.g., an assignment ID), and/or anyone/anything else pertaining to the student's academic information, or the user's information of interest. In various embodiments, a single identifier (e.g., a user profile identifier) may indicate multiple or all aspects of the associated user profile.

In various embodiments, a user profile 156 may associate and/or link with another user profile 156 and/or a user profile in SIS 130 and/or LMS 140 such that the user profiles 156 in notification system 150 may access and/or receive at least a portion of the information comprised in another user profile (e.g., located in SIS 130 and/or LMS 140). The link between two user profiles may provide an electronic communication channel between them. For example, a student user profile 156 may associate/link with the teacher profile in SIS 130 and/or LMS 140 for a class which the associated teacher is teaching, and in which the associated student is enrolled. That way, the student user profile 156 may be a monitoring user profile 156 associated with the teacher profile, which is the observed user profile, so the student user profile 156 may receive updates on the teacher profile related to a class in which the student is enrolled. Similarly, a parent user profile 156 for a parent of a student may associate/link to a student user profile (e.g., in SIS 130 and/or LMS 140), such that the parent is the monitoring user profile 156 and may monitor the student's academic information by accessing the associated student user profile (the observed user profile) and/or receiving information in parent user profile 156 regarding the associated student user profile, such as academic information and/or a notification regarding academic information.

User profiles may be linked in system 100 in various ways. In various embodiments, a parent or other person related to a student may be provided an access code to enter into notification system 150 through a monitoring user profile 156, which may be recognized by notification system 150 (or other component of system 100) as associated with a respective user profile. In response, the association and/or linking between the monitoring user profile 156 (e.g., a parent user profile) and the respective observed user profile (e.g., a student user profile in SIS 130 and/or LMS 140) may occur. An access code to associate and/or link with two user profiles may be provided to any user profile to link with another user profile as appropriate. In various embodiments, such an access code (which may be a series of letters or numbers, an email, and/or the like) may be requested and/or generated by a student user profile (or another observed user profile), and provided to another user or user profile 156. A student may take such action, for example, so that the student's parent's user profile in notification system 150 may become a monitoring user profile 156 associated with the respective student user profile in response to providing the access code to notification system 150 (or other component of system 100). In various embodiments, a user (e.g., a parent) may create a monitoring user profile 156, and in turn, an associated observed user profile may be created, which may be linked to the created monitoring user profile 156. For example, a parent of a student may create a parent profile (e.g., a monitoring user profile 156), and also register their student, creating a student user profile (e.g., an observed user profile), which may be automatically linked to the parent profile. In various embodiments, one user profile 156 may request to be linked to another user profile 156, and in response, the requested user profile 156 may approve or deny the linkage. In various embodiments, a user profile 156 may be linked to another user profile by an administrator or the like. For example, if a parent is able to demonstrate that they have a legal relationship to a student, a user profile associated with the parent (e.g., a parent profile) may be linked (e.g., by an administrator) to the student's student user profile, such that the parent profile is the monitoring user profile 156 and the student user profile is the observed user profile. In various embodiments, the links between user profiles within system 100 may limit the accessible information to certain classes, certain past academic information, or in any other suitable manner. In various embodiments, one or more of the linked user profiles within system 100 may terminate such linkage at any time.

In various embodiments, teacher profiles may be linked to a student user profile associated with each of their current students, and may be the monitoring user profile 156 only for academic information on the student user profile (the observed user profile) regarding the teacher's class. For example, the teacher profile and the student user profile may be automatically linked in response to the student enrolling in the teacher's class (e.g., by the student enrolling through the student user profile). Similarly, in response to a student enrolling in a teacher's class, the student user profile may be linked (e.g., automatically) to the respective teacher profile, such that the student user profile is the monitoring user profile 156 at least regarding the academic information posted in the teacher profile (the observed user profile in this regard) pertaining to the relevant class. Along similar lines, if a user having a user profile 156 joins a group (e.g., an academic class or student organization), the user profile 156 may be linked/associated (e.g., automatically, via request and approval, and/or the like) with one or more user profiles 156 also in the group (e.g., a teacher profile for a class, a user profile 156 for the president of the student organization, user profiles 156 for other students in the group, or the like).

In various embodiments, derivative linkages between related user profiles within system 100 may be implemented by system 100 and/or notification system 150. That is, if a first user profile is or becomes linked to a second user profile, and a third user profile is the monitoring user profile 156 over the first user profile, a reciprocal link may be created between the third user profile and the second user profile, such that the third user profile may be the monitoring user profile 156 over the second user profile. For example, if a parent profile is the monitoring user profile 156 for a student user profile, and the student profile is linked to a teacher profile, the parent profile may be linked (e.g., automatically, or by a code provided for the parent to input into the parent profile, or by request from the parent profile and approval from the teacher profile, or the like) to the teacher profile. Likewise, the teacher profile may be linked to the parent profile enabling monitoring of information and communication between the user profiles.

In various embodiments, one of the components of system 100 (e.g., notification system 150, SIS 130, and/or LMS 140) may comprise a database of the linkages/associations between user profiles. A linkage identifier may be generated and associated with each linkage between at least two user profiles. The linkage identifier may convey any suitable information, such as the nature of the relationship or association between the user profiles (e.g., parent/teacher, parent/student, student/teacher, or the like), the users associated with each user profile in the linkage (e.g., the user identifiers associated with the user profiles, such as student or teacher IDs), wherein the user identifiers may also indicate the role in the user profile association (e.g., which user is the teacher and which is the student, which is the monitoring user profile 156 and which is the observed user profile, etc.), and/or the like. The linkage identifier may be associated with and/or incorporated into the user profiles comprised in the linkage. Therefore, in response to notification system 150 (or any other component of system 100) analyzing a user profile and any associated linkage identifiers, notification system 150 may be able to determine other user profiles with which the subject user profile has an association, and the nature of such associations.

In various embodiments, a user profile of SIS 130, LMS 140, and/or notification system 150 may comprise more than one linkage identifier to identify that the subject user profile is associated with multiple other user profiles, or that the subject user profile has multiple relationship types with one or more user profiles. In various embodiments, a linkage identifier in a user profile may identify multiple linkages to other user profiles. In various embodiments, two user profiles may be associated with one another in more than one way. For example, a first user profile may belong to a teacher and parent, and a second user profile may belong to a student and child of the first user. Therefore, the first and second user profiles in this example may have a teacher/student association and a parent/child association. There may be one linkage identifier associated with and/or incorporated into the first and second user profiles in this example, which may indicate both association types, or there may be one linkage identifier for the teacher/student association and one identifier for the parent/child association (again, both linkage identifiers may be associated with and/or incorporated into the user profiles).

In various embodiments, notification system 150 may be configured to take actions based on identifiers (e.g., user identifiers, linkage identifiers, etc.). For example, in response to receiving information associated with a certain user profile (e.g., a student profile), notification system 150 may cause a notification to be sent to all user profiles associated with the certain user profile. Notification system 150 may determine which user profiles are associated with the certain user profile by detecting and analyzing the linkage identifier(s) in the certain user profile. Taken even further, the information associated with the certain user profile may be only relevant for a specific relationship type (e.g., the certain user's teachers), so notification system 150 may send notifications only to the certain user's teachers based on the classes in which the certain user is enrolled, the linkage identifiers indicating teacher/student relationships, or the like.

In various embodiments, notification system 150 may comprise a processor 152, portal 154, and/or a user profile 156. Any of the components of notification system 150 may be in electronic communication with one another. Processor 152 may be configured to receive inputs from the user, analyze and/or identify information, perform functions, or instruct/facilitate the performance of functions, of system 100 including, for example, identifying academic information about which a monitoring user profile 156 has instructed to receive a notification. As discussed, a processor (e.g., processor 152) may be comprised in any or all components of system 100 (e.g., web client 120, SIS 130, and/or LMS 140). Processor 152 may be further configured to present/display data and information (or cause data and information to be presented and/or displayed), such as notifications, to users of system 100 on a GUI, for example through portal 154, via display screen 122 of web client 120.

In various embodiments, notification system 150 and/or processor 152 may be configured to generate, store, select, transmit, and/or display notifications to a user on a GUI via display screen 122 of web client 120. In various embodiments, a notification may be generated in response to notification system 150 and/or processor 152 detecting academic information about an observed user profile (e.g., in SIS 130, LMS 140, and/or notification system 150), which the user of the associated monitoring user profile 156 (e.g., a parent of the student) has indicated is relevant. In various embodiments, the notification generated and/or presented to user profile 156 may comprise a symbol, text, or other indicator of the information which the notification is regarding. For example, the notification may comprise a symbol (e.g., a letter grade for assignment or exam scores, a clock for attendance, or the like) or word (e.g., “scores,” “attendance,” etc.) indicating a notification subject, and/or a synopsis or explanation of the information to which the notification is associated. In various embodiments, the notifications generated by notification system 150 and/or processor 152 may be push notifications transmitted to the user's web client 120 and automatically displayed on display screen 122 (e.g., without action by the user). Such push notifications may be displayed on display screen 122 on a home screen GUI, or any other GUI displayed by web client 120.

In various embodiments, notification system 150 may comprise a portal 154. Portal 154 may comprise a GUI, may take different forms and/or comprise various features, and may be presented on display screen 122 of web client 120. Portal 154 may comprise an input device(s) displayed on display screen 122 which, in response to being selected, allows a user of system 100 to produce an input signal received by processor 152, which may command processor 152 to perform or facilitate performance of an operation. For example, the input device may be a digital button displayed on display screen 122 (e.g., a touch screen) which may be selected by tapping the screen on a touch screen or selecting the input device with a computer mouse, and/or the input device may be a physical button to input information.

In various embodiments, portal 154 may display on display screen 122 various notifications generated and presented to the user by notification system 150 and/or processor 152, or variations of the such notifications (e.g., thumbnail or tab versions). In various embodiments, portal 154 be incorporated into a user's user profile 156, and/or portal 154 may display links to user profiles associated with the user profile 156 in notification system 150 (e.g., a parent profile in SIS 130 and/or LMS 140), links to the student user profile for the student associated with the user, or other materials relevant to the student's education. The notifications (or variations thereof) displayed on portal 154 may operate as input devices and may be links to the information associated with the respective notification, such that the user may select the notification, processor 152 may receive such a selection, and the user may be directed to the information located in and/or accessible through SIS 130 and/or LMS 140 associated with the notification. Push notifications presented to the user, as discussed herein may operate, in a similar manner. In various embodiments, the information associated with the notification may be stored or located within notification system 150. Therefore, selection of a notification may cause processor 152 to navigate to the associated information and/or display such information on the GUI.

In various embodiments, portal 154 may allow a user to set the settings regarding the notifications the user will receive. Rather than sifting through all available information related to a student's education in SIS 130, LMS 140, and/or notification system 150, the user of notification system 150 may elect about which information the user will receive notifications, and/or which information will be displayed or comprised in portal 154. The user may indicate to notification system 150, through selection of an input device in portal 154, the academic information about which the user wants to remain informed by selecting a filter parameter. Each filter parameter may be associated with one or more desired information attributes of academic information (i.e., filter parameters may indicate to notification system 150 the types of academic information about which to notify the user of the monitoring user profile 156). Processor 152 may receive the selected filter parameter(s), which indicate a desired information attribute of academic information received, e.g., an event type, event characteristic, time lapse or frequency, trends, and/or any other parameter related to an academic event, in which the user of notification system 150 is interested. For example, the user may elect to remain informed (i.e., receive notifications from notification system 150) about a student's test grades, overall grades, attendance, material postings, and/or other academic event types. That is, an academic event may be reflected by a test grade, overall grade update, attendance event, and/or materials (e.g., information materials, such as reading or homework assignments) becoming available within system 100 for an observed user profile, processor 152 may identify the desired information attribute(s) in the available academic information (associated with the filter parameter(s) selected by the user), generate a notification associated with the academic information comprising the desired information attribute, and transmit a notification to the monitoring user profile 156 of notification system 150. The notification may convey to the user of the monitoring user profile 156 that there is relevant information available (which may be recent or dated information).

In various embodiments, the user may elect (e.g., by selecting one or more filter parameters) to remain informed about academic information from an academic event having an event characteristic. For example, the user may elect and indicate to notification system 150 that the user would like to be informed only about test scores (the event type) above and/or below a certain level (the event characteristic) (e.g., notification system 150 may be instructed by the user to transmit a notification to the monitoring user profile 156 in response to a test score below 70% or above 95% in the observed user profile), about an overall grade dropping (the event type) below or rising above a certain level (the event characteristic), about absences or tardiness (the event characteristic) in attendance (the event type), and/or the like. In various embodiments, the user may elect to remain informed about academic information after a time lapse or certain frequency (i.e., periodic updates), for example, receive an overall grade update monthly, or an overall grade update after every exam or every third exam, or an attendance record weekly, or the like. In various embodiments, the user may elect to remain informed about trends (e.g., uncharacteristic trends) in a student's academic performance or behavior. For example, a user of notification system 150 may indicate to notification system 150 that the user would like to receive a notification in response to a student receiving lower scores (e.g., below 70%) on two or more examinations or assignments in a row, or two absences in a week, or the like.

In various embodiments, notification system 150 may act as a bridge and/or middleware between SIS 130 and LMS 140. Notification system 150, through integration with SIS 130 and/or LMS 140, may be able to access and analyze academic information (or any available type of information) generated and/or stored within SIS 130 and/or LMS 140. Based on the analysis of academic information in SIS 130 and/or LMS 140, notification system 150 may be able to determine academic information of interest to respective monitoring user profiles 156, and in response, generate and transmit notifications notifying the appropriate monitoring user profile 156 of the presence of requested academic information.

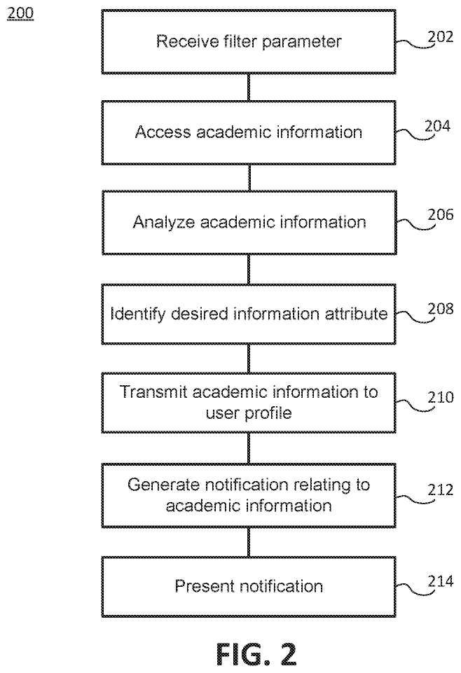

Referring now to FIG. 2, the process flow depicted merely reflects embodiments and is not intended to limit the scope of the disclosure. For example, the steps recited in any of the method or process descriptions may be executed in any order and are not limited to the order presented. It will be appreciated that the following description makes appropriate references not only to the steps and user interface elements depicted in FIG. 2, but also to the various system components as described above with reference to FIG. 1.

FIG. 2 depicts a method 200 of generating and presenting notifications to a user via system 100. With combined reference to FIGS. 1 and 2, academic information may be stored in SIS 130, LMS 140, and/or notification system 150. Notification system 150 may integrate (e.g., via an API), or otherwise be in electronic communication, with SIS 130 and/or LMS 140, such that notification system 150 may access, retrieve, and/or analyze academic information from SIS 130 and/or LMS 140. Academic information may be input or received into SIS 130, LMS 140, and/or notification system 150, for example, by a teacher or student inputting such academic information (e.g., class enrollments, assignments or tests, grades, assignment or test scores or answers, attendance, or the like). Academic information may also be generated by SIS 130 and/or LMS 140, by, for example, SIS 130 and/or LMS 140 automatically grading assignment or test answers input by a student (or instructor) through a student (or teacher profile), generating attendance information in response to detecting a student user profile in SIS 130 and/or LMS 140 becoming active (or remaining inactive) during an electronic class, enrolling a student in or dropping a student from a class, and/or the like.

In various embodiments, the academic information in SIS 130, LMS 140, and/or notification system 150 may be associated with (and/or stored with) a user profile in SIS 130, LMS 140, and/or notification system 150, respectively. For example, scores for a student may be associated with the student's student user profile in SIS 130, LMS 140, and/or notification system 150 based on the input method used to input the academic information into SIS 130, LMS 140, and/or notification system 150 (e.g., a test score or attendance record may be input into the student user profile directly or through an input device in a user profile, such as a teacher profile, receiving the academic information linked to the student user profile). Each piece of academic information may be marked by SIS 130, LMS 140, and/or notification system 150 with an identifier, identifying the associated student and/or student user profile (e.g., a student ID), the associated instructor and teacher profile (e.g., a teacher ID), the associated school (e.g., a school ID), the student section that the student is in (e.g., a section ID), the associated class (e.g., a course ID), a specific assignment (e.g., an assignment ID), and/or anyone/anything else pertaining to the student's academic information and/or an associated user profile. In various embodiments, one identifier associated with a piece of academic information (e.g., a series of numbers, letters, symbols, and/or the like) may indicate or identify any or all characteristics of the piece of academic information, such as those listed above. In various embodiments, one identifier associated with a piece of academic information may be present for each characteristic of the academic information.

Anyone interested in a student's academic performance and/or behavior may request access to the academic information associated with the student stored in and/or available through SIS 130, LMS 140, and/or notification system 150. Access may be granted to academic information associated with and/or stored in the respective student user profile or teacher profile associated with the student in SIS 130, LMS 140, and/or notification system 150. However, the amount of academic information associated with a student of interest stored in and/or made available through SIS 130, LMS 140, and/or notification system 150 may be voluminous. The amount of academic information associated with a student may be too great for a person to monitor in a meaningful or efficient way. Therefore, the user may create a user profile 156 (a monitoring user profile 156) with notification system 150, which is configured to notify a user of certain academic information (e.g., updates or statuses) becoming available in an observed user profile (e.g., in SIS 130, LMS 140, and/or notification system 150) as dictated by the user's preferences in the monitoring user profile 156.

A user may register with notification system 150 to create a monitoring user profile 156 therein. In various embodiments, a user may register with notification system 150 by providing login information (e.g., username, password, email address, etc.). The user may associate the monitoring user profile 156 with a user profile (e.g., a student user profile) in SIS 130, LMS 140, and/or another user profile 156 in notification system 150, making that profile the observed user profile. In various embodiments, the observed user profile may approve the association with the monitoring user profile 156, and/or the parent or other person registering the monitoring user profile 156 may have received permission, or may otherwise automatically, or have the ability to, associate and monitor the observed user profile (e.g., a parent may be provided a password, code, or the like to enter into their monitoring user profile 156 in notification system 150 which will associate and/or link the monitoring user profile 156 with the respective observed user profile). In various embodiments, the monitoring user profile 156 and the observed user profile may be the same user profile, or may belong to the same user, such that the user may receive notifications in response to information relating to his or herself becoming available.

In various embodiments, in response to new academic information related to a student's education being entered or otherwise received and made available by SIS 130, LMS 140, and/or notification system 150 (e.g., by a teacher entering an information for an academic event such as exam scores, or SIS 130, LMS 140, and/or notification system 150 receiving and grading a student's assignment submission, etc.), notification system 150 may identify the user profile with which the academic information relates (e.g., a student user profile in SIS 130, LMS 140, and/or notification system 150). New academic information may be information recently received (e.g., in real time or near real time, for example, within two hours of an event happening or the information being available), and/or information comprising recently received and/or updated information. In response to identifying the user profile associated with the new academic information, notification system 150 may identify any associated and/or linked user profiles 156 to the identified user profile (e.g., a parent user profile 156). An associated user profile 156 which is monitoring the student user profile, is the monitoring user profile 156, and the student user profile 156 is the observed user profile, as discussed herein. Notification system 150 may identify the association/link between two or more user profiles by, for example, identifying electronic communication or linkage between the user profiles. As another example, a user profile may comprise a tag(s) or marker(s) indicating a link to another user profile, which may also identify the linked user profile. Such a tag or marker in a user profile may identify one or more linked user profiles.

The user of the monitoring user profile 156 may select a filter parameter(s) indicating about which academic information in the observed user profile to receive notifications in the monitoring user profile 156. The parameter filter(s) is associated with a desired information attribute(s), so academic information from or associated with the observed user profile having the desired information attribute(s) is conveyed to the monitoring user profile 156 (e.g., via a notification). The user of the monitoring user profile 156 may select one or more filter parameters, or combinations of filter parameters, by selecting input devices in portal 154. In response, notification system 150 may receive and/or identify a filter parameter (step 202) selected in the monitoring user profile 156. As discussed herein, a filter parameter may indicate that the user of the monitoring user profile 156 may wish to be notified of academic information as it becomes available, such as test grades, test grades above or below a certain threshold, overall grades, overall grades above or below a certain threshold, the student's grade point average, if the student's grade point average above or below a certain threshold, an attendance status, homework completion or incompletion, or the like. Additionally or alternatively, in various embodiments, a filter parameter may indicate that the user of the monitoring user profile 156 may desire to receive periodic updates such as weekly, monthly, etc., or if there is a trend, such as three attendance delinquencies in a row or in a week, a number of test or assignment scores below or above a threshold over a certain period of time, or the like.

In various embodiments, SIS 130, LMS 140, and/or notification system 150 may receive new academic information associated with a recent academic event. SIS 130, LMS 140, and/or notification system 150 may identify the user profile associated with the new academic information (e.g., student user profile, teacher user profile, etc.) and associate and/or place the new academic information with the respective user profile. The academic information associated with a student and the respective student user profile may be input into and/or associated with the student user profile (e.g., in SIS 130, LMS 140, and/or notification system 150). The new academic information may be directly input into the student user profile, input into a teacher user profile associated with the student user profile and transmitted to the student user profile, generated by SIS 130, LMS 140, and/or notification system 150 (e.g., by automatically grading an assignment entered into system 100), or the like. In response to the academic information being received, the academic information may be marked with markers or identifiers to indicate information attributes of the academic information (e.g., an event type, event characteristic, date, time span, the number of times such an event or event having a certain characteristic has occurred, or the like). Similarly, as described herein, a marker or identifier associated with or incorporated into the academic information may additionally or alternatively indicate an associated student/student user profile, teacher/teacher profile, school, student section, class, assignment, or the like. In various embodiments, the markers or identifiers may be incorporated into or associated with the respective academic information.

In various embodiments, each distinct attribute of academic information may have a distinct marker/identifier, and/or one marker identifier may reflect a combination of attributes comprised in academic information. For example, one marker/identifier associated with academic information may indicate academic information reflecting a certain event type, while another marker identifier associated with academic information may indicate a certain event type having a certain event characteristic. Or, one marker/identifier associated with academic information may indicate academic information reflecting a certain event type, while a separate marker identifier may indicate an event characteristic of the event type. In various embodiments, the markers/identifiers may be associated with an input category in which the new academic information is input or received, and each input category may have an associated marker/identifier that the academic information therein receives. For example, all new academic information input into a “test score” category receives a marker/identifier indicating such academic information is relating to a test, as well as markers/identifiers relating to other attributes of the academic information (e.g., related to a score, letter grade, etc.). As discussed, one marker/identifier may indicate more than one information attribute of the academic information. In various embodiments, academic information with a certain attribute may be placed in a data bucket with a marker/identifier for that information attribute and respective data bucket (e.g., all test scores go in a “test” bucket).

Notification system 150 and/or processor 152 may access the academic information (step 204). For example, the academic information may be input into notification system 150, accessed by notification system 150 within SIS 130 and/or LMS 140, and/or transferred, or retrieved by notification system 150 and/or processor 152 from SIS 130 and/or LMS 140 through the integration between SIS 130, LMS 140, and/or notification system 150. Therefore, the integration between SIS 130, LMS 140, and/or notification system 150 allows notification system 150 access to more academic information related to a student, teacher, class, etc.

In various embodiments, notification system 150 and/or processor 152 may analyze the new academic information (step 206) received for desired information attributes associated with the filter parameters selected by the user of the monitoring user profile 156. In analyzing the new academic information, notification system 150 and/or processor 152 may recognize the association between the filter parameters selected by the user of the monitoring user profile 156, the desired information attributes associated with the selected filter parameters, and the identifiers/markers associated with the desired information attributes. Therefore, notification system 150 and/or processor 152 may parse the new academic information based on the markers/identifiers comprised therein or associated therewith. In response, notification system 150 and/or processor 152 may recognize and/or identify a desired information attribute (step 208) (e.g., by recognizing and/or identifying a marker/identifier associated with a desired information attribute and/or filter parameter) in the new academic information.

In response to identifying a desired information attribute in the new academic information, notification system 150 and/or processor 152 may transmit, and/or cause SIS 130 or LMS 140 to transmit, the new academic information comprising the identified desired information attribute to a user profile (step 210). The user profile receiving the new academic information may be the monitoring user profile 156 and/or a user profile in SIS 130 and/or LMS 140 linked or associated to monitoring user profile 156. That way, the user associated with the monitoring user profile 156 may log into the user profile receiving the new academic information to view it. Because the user selected in the monitoring user profile 156 certain filter parameters to dictate what academic information would be of interest, and the new academic information in this example comprises desired information attributes associated with the selected filter parameters, the academic information transmitted for viewing by the user will be of interest to the user. Therefore, notification system 150 may scan all incoming academic information associated with observed user profile for the desired information attributes, and identify that which the user of the monitoring user profile 156 will be interested.

In response to identifying a desired information attribute in the new academic information, notification system 150 may generate a notification relating to the academic information (step 212) found to be of interest to the user of the monitoring user profile 156. The notification may be a shape displayed on display screen 122 of web client 120 comprising an of indicator of the content of the academic information of interest identified by notification system 150. The indicator may be a graphic symbol associated with the desired information attribute (e.g., an image of a chair for an attendance event, a pencil and paper for a test or assignment event, or the like), text with one or more words describing the desired information attribute, and/or a short synopsis or an explanation of the academic information identified as relevant by notification system 150.

In various embodiments, the notification may be displayed and/or presented (step 214) in the monitoring user profile 156, in the portal 154, in SIS 130, and/or in LMS 140 (e.g., on a home page that is the first thing a user sees in response to logging into user profile 156). Alternatively or additionally, the notification may be a push notification that is automatically displayed on display screen 122 of web client 120 in response to an academic event and notification system 150 identifying a desired information attribute in the associated academic information, so that in response to the user simply looking at display screen 122, the notification is automatically displayed for viewing. Further information about the relevant academic information may be accessed in the user profile of notification system 150, SIS 130, and/or in LMS 140 by, for example, selecting the displayed notification, which acts as an input. In response to selecting the notification, the user maybe directed to the more detailed relevant academic information.

The presentation of such notifications (e.g., presented in a user profile, as push notifications, or the like) may result in improvements to the operations of web client 120. The improvements may include 1) a reduction of the processing load on web client 120 that results in increased available memory, processing capacity, and processing speed of web client 120; and 2) a reduction to the power consumption of web client 120 that results in a longer period of time between battery charges of web client 120.

More particularly, the presentation of notifications reduces the processing load on web client 120 in two different ways. First, system 100 and/or notification system 150 may require a link to access the information associated with a notification, wherein the link is sent to web client 120. This significantly reduces the processing load that is required to search for and obtain the associated information. Therefore, system 100 and/or notification system 150 may reduce the processing load on web client 120. The reduced processing load results in increased available memory, processing capacity, and processing speed of web client 120. Second, displaying information on the notification and/or from the link in the notification reduces the number of superfluous screens (i.e., screens that do not include the relevant and timely information) that are displayed. That is, by skipping the step of displaying a superfluous home screen or unneeded sub-webpages (when searching for the information associated with or comprised in the notification), web client 120 displays the relevant screen, such that the total number of screens that are displayed is reduced. Switching between screens increases the processing load on web client 120. Therefore, by omitting superfluous screens (and the switching between the superfluous screens), system 100 and/or notification system 150 may reduce the processing load on web client 120. The reduced processing load may result in increased available memory, processing capacity, and processing speed of web client 120.

System 100 and/or notification system 150 may also reduce the power consumption of web client 120 in two different ways. First, web client 120 does not need to use resources to search for the information associated with a notification. As such, the power consumption associated with web client 120 is reduced. This prevents web client 120 from draining battery power from the battery of web client 120, and therefore, increases the operational life of web client 120 between battery charges. Second, displaying the relevant screen as without superfluous screens reduces the total amount of time in which a display or the display lights must be powered on. For example, if there were three superfluous screens displayed prior to the relevant screen, the user might spend 20 seconds navigating through the superfluous screens before the relevant screen was displayed. Powering the display on during these 20 seconds expends energy and drains the battery power of web client 120. Thus, by displaying the relevant screen with the information of interest, web client 120 preserves the battery power that would have been needed for the 20 seconds of navigating through the superfluous screens. Therefore, selecting to display the relevant screen through the notification reduces the amount of time in which the display must be powered on and preserves battery life of web client 120 to increase the operational life of web client 120 between battery charges.

In various embodiments, a communication application 160 may be in electronic communication with notification system 150 and/or web client 120. Communication application 160 may be a social media platform or website such as Facebook®, Twitter®, Instagram®, or the like, or another communication channel such as email. In various embodiments, the user of monitoring user profile 156 may elect to have notifications converted into a communication through another channel, such as communication application 160. For example, a user of monitoring user profile 156 may not often check monitoring user profile 156 in notification system 150, or a user profile in SIS 130 and/or LMS 140, but may communicate via a communication application 160 more frequently. Therefore, the user may elect in the monitoring user profile 156 through portal 154, for example, that the user would like to receive communications as messages in the communication application 160 of choice.

In various embodiments, the notification may comprise a link to the user profile in SIS 130, LMS 140, and/or notification system 150 where the academic information is available. That way, the user may view the generated and displayed notification, decide whether they want to review for more information, and if so, select the link in the notification and be taken to the new academic information comprising the desired information attribute. Notification system 150 may receive the selection and redirect the user to the respective user profile for information viewing. The integration between SIS 130, LMS 140, and/or notification system 150 facilitates and streamlines directing the user to the location where the new academic location is stored and/or otherwise available for access. Notification system 150 may also provide an indicator on the notification in the monitoring user profile 156 of which notifications and/or associated academic information has been viewed or not viewed.

In various embodiments, in response to identifying a desired information attribute (step 208) in new academic information, notification system 150 may identify a problem in the associated student's performance and/or behavior (e.g., a bad trend in behavior, a weak subject area, etc.). For example, if the new academic information reflects two tardy attendance marks in a week, notification system 150 may identify the problem of tardiness, or if the student scores low on a test or assignment, notification system 150 may identify a weakness in a certain subject, or with a certain instructor. In response, notification system 150 may provide a suggested action to improve the situation such as point out the weakness in a certain subject and suggest relevant study materials or suggest a course transfer for a different instructor if available or offer to set reminders and display them through user profile 156 for class time and assignment due dates (as notifications to the student or parent).

Overall, system 100 with notification system 150 allows a user of a monitoring user profile 156 to easily dictate what academic information associated with the observed user profile is brought to the monitoring user profile's 156 attention. Additionally, the notifications generated in response to identifying desired information attributes in new academic information allows a convenient display and conveyance of the notification, allowing the user to decide whether to access and view the new academic information in its entirety. Finally, users of a monitoring user profile 156 may remain apprised of new academic information associated with the observed user profile in real time or near real time, thus allowing the capability to address any potential problems or poor habits, and/or give praise when praise is due.

Though this description is in the context of an educational system involving academic information, it should be understood that the system described herein and its various elements may be implemented in different technological and contextual applications without going outside the scope of this disclosure.

Systems, methods and computer program products are provided. In the detailed description herein, references to “various embodiments”, “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, “satisfy”, “meet”, “match”, “associated with” or similar phrases may include an identical match, a partial match, meeting certain criteria, matching a subset of data, a correlation, satisfying certain criteria, a correspondence, an association, an algorithmic relationship and/or the like.

Terms and phrases similar to “associate” and/or “associating” may include tagging, flagging, correlating, using a look-up table or any other method or system for indicating or creating a relationship between elements, such as, for example, (i) a user and (ii) a user profile, or (i) a filter parameter, (ii) an information attribute, and/or (iii) academic information. Moreover, the associating may occur at any point, in response to any suitable action, event, or period of time. The associating may occur at pre-determined intervals, periodic, randomly, once, more than once, or in response to a suitable request or action. Any of the information may be distributed and/or accessed via a software enabled link, wherein the link may be sent via an email, text, post, social network input and/or any other method known in the art.

Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors. Various database tuning steps are contemplated to optimize database performance. For example, frequently used files such as indexes may be placed on separate file systems to reduce In/Out (“I/O”) bottlenecks.

The system and method may be described herein in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, JAVA®, JAVASCRIPT, VBScript, Macromedia Cold Fusion, COBOL, MICROSOFT® Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JAVASCRIPT, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “JAVA® Cryptography” by Jonathan Knudson, published by O'Reilly & Associates (1998); (3) “Cryptography & Network Security: Principles & Practice” by William Stallings, published by Prentice Hall; all of which are hereby incorporated by reference.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Various databases used herein may include: client data; merchant data; financial institution data; and/or like data useful in the operation of the system. As those skilled in the art will appreciate, user computer may include an operating system (e.g., WINDOWS®, OS2, UNIX®, LINUX®, SOLARIS®, MacOS, etc.) as well as various conventional support software and drivers typically associated with computers.

The present system or any part(s) or function(s) thereof may be implemented using hardware, software or a combination thereof and may be implemented in one or more computer systems or other processing systems. However, the manipulations performed by embodiments were often referred to in terms, such as matching or selecting, which are commonly associated with mental operations performed by a human operator. No such capability of a human operator is necessary, or desirable in most cases, in any of the operations described herein. Rather, the operations may be machine operations or any of the operations may be conducted or enhanced by Artificial Intelligence (AI) or Machine Learning. Useful machines for performing the various embodiments include general purpose digital computers or similar devices.

In fact, in various embodiments, the embodiments are directed toward one or more computer systems capable of carrying out the functionality described herein. The computer system includes one or more processors, such as processor. The processor is connected to a communication infrastructure (e.g., a communications bus, cross-over bar, or network). Various software embodiments are described in terms of this exemplary computer system. After reading this description, it will become apparent to a person skilled in the relevant art(s) how to implement various embodiments using other computer systems and/or architectures. Computer system can include a display interface that forwards graphics, text, and other data from the communication infrastructure (or from a frame buffer not shown) for display on a display unit.

As used herein an “identifier” may be any suitable identifier that uniquely identifies something such as a user profile, information, or the like.

As will be appreciated by one of ordinary skill in the art, the system or any of its components may be embodied as a customization of an existing system, an add-on product, a processing apparatus executing upgraded software, a standalone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user WINDOWS®, webpages, websites, web forms, prompts, etc. Practitioners will appreciate that the illustrated steps described herein may comprise in any number of configurations including the use of WINDOWS®, webpages, web forms, popup WINDOWS®, prompts and the like. It should be further appreciated that the multiple steps as illustrated and described may be combined into single webpages and/or WINDOWS® but have been expanded for the sake of simplicity. In other cases, steps illustrated and described as single process steps may be separated into multiple webpages and/or WINDOWS® but have been combined for simplicity.

As used herein, “transmit” may include sending electronic data from one system component to another over a network connection. Additionally, as used herein, “data” or “information” may include encompassing information such as commands, queries, files, data for storage, and the like in digital or any other form.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, Internet, point of interaction device (point of sale device, personal digital assistant (e.g., IPHONE®, BLACKBERRY®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Moreover, although the system is frequently described herein as being implemented with TCP/IP communications protocols, the system may also be implemented using IPX, APPLE®talk, IP-6, NetBIOS®, OSI, any tunneling protocol (e.g. IPsec, SSH), or any number of existing or future protocols. If the network is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA® 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to the network via data links which includes, for example, a connection to an Internet Service Provider (ISP) over the local loop as is typically used in connection with standard modem communication, cable modem, Dish Networks®, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that the network may be implemented as other types of networks, such as an interactive television (ITV) network. Moreover, the system contemplates the use, sale or distribution of any goods, services or information over any network having similar functionality described herein.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” and “non-transitory computer-readable storage medium” should be construed to exclude only those types of transitory computer-readable media which were found in In Re Nuijten to fall outside the scope of patentable subject matter under 35 U.S.C. § 101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to ‘at least one of A, B, and C’ or ‘at least one of A, B, or C’ is used in the claims or specification, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C. Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described various embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims.

No claim element is intended to invoke 35 U.S.C. 112(f) unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

What is claimed is:

1. A method, comprising:
receiving, by a processor, a filter parameter associated with a desired information attribute, wherein the filter parameter indicates that academic information having the desired information attribute is relevant to a monitoring user profile;
accessing, by the processor, new academic information associated with an academic event;
analyzing, by the processor, the new academic information for the desired information attribute associated with the filter parameter;
identifying, by the processor, the desired information attribute in the new academic information;
generating, by the processor, a notification in response to the identifying the desired information attribute in the new academic information; and
presenting, by the processor, the notification on a user device associated with the monitoring user profile.

2. The method of claim 1, wherein the filter parameter is received from the monitoring user profile, wherein the monitoring user profile is associated with an observed user profile, and wherein the new academic information is associated with the observed user profile.

3. The method of claim 2, further comprising linking, by the processor, the monitoring user profile and the observed user profile such that the monitoring user profile has access to information associated with the observed user profile.

4. The method of claim 2, further comprising:
associating, by the processor, the new academic information comprising the desired information attribute with the monitoring user profile, such that the new academic information comprising the desired information attribute is available in the monitoring user profile.

5. The method of claim 4, further comprising:
receiving, by the processor, a selection of the notification presented on the user device;
presenting, by the processor, the new academic information comprising the desired information attribute on the user device associated with the monitoring user profile in response to the receiving the selection of the notification.

6. The method of claim 2, wherein the notification comprises at least one of the filter parameter, the desired information attribute, the new academic information, or a symbol or text representing at least one of the filter parameter, the desired information attribute, or the new academic information associated with the academic event.

7. The method of claim 6, wherein the notification comprises the text representing at least one of the filter parameter, the desired information attribute, or the new academic information associated with the academic event, wherein the text comprises a summary of the new academic information comprising the desired information attribute.

8. The method of claim 2, wherein filter parameter is associated with an academic event type, an academic event characteristic, a trend, a time lapse, or a frequency within the new academic information.

9. The method of claim 1, wherein the notification comprises a suggested action to address a problem associated with the new academic information comprising the desired information attribute.

10. A system, comprising:
a processor;
a tangible, non-transitory memory configured to communicate with the processor,
the tangible, non-transitory memory having instructions stored thereon that, in response to execution by the processor, cause the processor to perform operations comprising:
receiving, by the processor, a filter parameter associated with a desired information attribute, wherein the filter parameter indicates that academic information having the desired information attribute is relevant to a monitoring user profile;
accessing, by the processor, new academic information associated with an academic event;
analyzing, by the processor, the new academic information for the desired information attribute associated with the filter parameter;
identifying, by the processor, the desired information attribute in the new academic information;
generating, by the processor, a notification in response to the identifying the desired information attribute in the new academic information; and
presenting, by the processor, the notification on a user device associated with the monitoring user profile.

11. The system of claim 10, wherein the filter parameter is received from the monitoring user profile, wherein the monitoring user profile is associated with an observed user profile, and wherein the new academic information is associated with the observed user profile.

12. The system of claim 11, wherein the operations further comprise linking, by the processor, the monitoring user profile and the observed user profile such that the monitoring user profile has access to information associated with the observed user profile.

13. The system of claim 11, wherein the operations further comprise:
associating, by the processor, the new academic information comprising the desired information attribute with the monitoring user profile, such that the new academic information comprising the desired information attribute is available in the monitoring user profile.

14. The system of claim 13, wherein the operations further comprise:
receiving, by the processor, a selection of the notification presented on the user device;
presenting, by the processor, the new academic information comprising the desired information attribute on the user device associated with the monitoring user profile in response to the receiving the selection of the notification.

15. The system of claim 11, wherein the notification comprises at least one of the filter parameter, the desired information attribute, the new academic information, or a symbol or text representing at least one of the filter parameter, the desired information attribute, or the new academic information associated with the academic event.

16. The system of claim 15, wherein the notification comprises the text representing at least one of the filter parameter, the desired information attribute, or the new academic information associated with the academic event, wherein the text comprises a summary of the new academic information comprising the desired information attribute.

17. The system of claim 11, wherein filter parameter is associated with an academic event type, an academic event characteristic, a trend, a time lapse, or a frequency within the new academic information.

18. The system of claim 10, wherein the notification comprises a suggested action to address a problem associated with the new academic information comprising the desired information attribute.

19. An article of manufacture including a non-transitory, tangible computer readable storage medium having instructions stored thereon that, in response to execution by a processor of a processing machine, cause the processor to perform operations comprising:
receiving, by the processor, a filter parameter associated with a desired information attribute, wherein the filter parameter indicates that academic information having the desired information attribute is relevant to a monitoring user profile;
accessing, by the processor, new academic information associated with an academic event;
analyzing, by the processor, the new academic information for the desired information attribute associated with the filter parameter;
identifying, by the processor, the desired information attribute in the new academic information;
generating, by the processor, a notification in response to the identifying the desired information attribute in the new academic information; and
presenting, by the processor, the notification on a user device associated with the monitoring user profile.

20. The article of claim 19, wherein the operations further comprise:
receiving, by the processor, a selection of the notification presented on the user device;
presenting, by the processor, the new academic information comprising the desired information attribute on the user device associated with the monitoring user profile in response to the receiving the selection of the notification.
